(19) United States
(12) Patent Application Publication
(10) Pub. No.: US 2026/0008047 A1
(43) Pub. Date: Jan. 8, 2026

(54) CHIP AND MANUFACTURING METHOD THEREOF

(71) Applicant: GeneMind Biosciences Co., Ltd., Shenzhen (CN)

(72) Inventor: Guang Li, Shenzhen (CN)

(21) Appl. No.: 19/256,634

(22) Filed: Jul. 1, 2025

(30) Foreign Application Priority Data
Jul. 2, 2024 (CN) 202410891713.5

(51) Int. Cl. B01L 3/00

(52) U.S. Cl. CPC B01L 3/502; B01L 2200/0689; B01L 2200/12; B01L 2300/0816; B01L 2300/0877; B01L 2300/0887

(57) ABSTRACT

The present application discloses a chip and a manufacturing method thereof. The chip includes a sheet assembly. The sheet assembly includes a first half part and a second half part arranged in parallel with the first half part along a width direction of the chip. The first half part is provided with a first channel; the first half part is provided with a first bottom surface, and a through hole that penetrates through the first bottom surface and communicates with the first channel is formed on the first half part. The second half part is provided with a second bottom surface flush with the first bottom surface. The second bottom surface is a structurally continuous unbroken plane. In this way, a reagent solution can enter the first channel from the through hole and circulate in the first half part of the chip. The bottom surface of the second half part is flush with the bottom surface of the first half part, which can reduce the likelihood of anomalies occurring when the first half part and the second half part are vacuum-adsorbed on the carrier platform. The second bottom surface is a structurally continuous unbroken plane, which can prevent the reagent solution from entering the second half part and serve to fill the chip, realizing the purpose of small-amount sequencing while the chip is adapted to the carrier platform.

### TECHNICAL FIELD

The present disclosure relates to the field of gene sequencing, and in particular, to a chip and a manufacturing method thereof.

### BACKGROUND

The chip adapted to the sequencing platform is a reaction apparatus, also called a flow chamber or flow cell, capable of carrying a nucleic acid under test and accommodating a solution to provide a reaction environment or a detection environment for the nucleic acid under test.

On platforms that use an optical imaging system to detect the chip for sequencing (sometimes referred to as a sequencer), imaging is performed on a specific position (a position to which a nucleic acid molecule under test is connected, and sometimes also referred to as a reaction region or a fluid channel) of the chip, and then, the base sequence of the nucleic acid molecule under test is identified and determined based on the information of the images. Specifically, for example, on platforms that use optically labeled nucleotides and based on the sequencing-by-synthesis principle to perform sequencing, during the sequencing, sequencers irradiate and excite the labeled in a reagent solution to emit optical signals, then capture the optical signals, for example, by photographing to acquire images, and finally identify and determine the base sequence based on the information of the images to achieve the purpose of sequencing.

In the related art, the chip is divided into a 4-channel chip and an 8-channel chip. The size of the 8-channel chip is greater than that of the 4-channel chip. When an 8-channel sequencer is used to perform a small-amount sequencing, only 4 channels are needed, and other channels in the 8-channel chip may lead to the waste of the reagent solution. However, the 4-channel chip cannot be placed on a carrier apparatus adapted to the 8-channel chip.

### SUMMARY

The present disclosure provides a chip and a manufacturing method thereof.

The chip according to the embodiments of the present disclosure includes a sheet assembly, the sheet assembly including a first half part and a second half part arranged in parallel with the first half part along a width direction of the chip, where the first half part is provided with a first channel;

the first half part is provided with a first bottom surface, and a through hole that penetrates through the first bottom surface and communicates with the first channel is formed on the first half part; the second half part is provided with a second bottom surface flush with the first bottom surface, the second bottom surface being a structurally continuous unbroken plane.

In this way, a reagent solution can enter the first channel from the through hole and circulate in the first half part of the chip. The bottom surface of the second half part is flush with the bottom surface of the first half part, which can reduce the likelihood of anomalies occurring when the first half part and the second half part are vacuum-adsorbed on the carrier platform. The second bottom surface is a structurally continuous unbroken plane, which can prevent the reagent solution from entering the second half part and serve to fill the chip, realizing the purpose of small-amount sequencing while the chip is adapted to the carrier platform.

In some embodiments, the first half part and the second half part are of a split structure.

In this way, it facilitates the disassembly and maintenance of the first half part and the second half part separately, reducing the maintenance cost of the chip.

In some embodiments, the first half part includes a first substrate and a first top plate arranged opposite the first substrate, the first channel is formed between the first substrate and the first top plate, the first substrate is provided with the first bottom surface, and the through hole is formed on the first substrate.

In this way, the first channel formed between the first substrate and the first top plate allows a reagent solution to circulate in the first half part; the through hole allows fluid such as the reagent solution to flow from the through hole into the first channel and flow out from the through hole after reaction.

In some embodiments, the first half part further includes a first connecting layer arranged between the first substrate and the first top plate, the first channel is formed on the first connecting layer, and the first channel penetrates through the first connecting layer in a thickness direction of the first connecting layer.

In this way, the first connecting layer can fixedly connect the first substrate and the first top plate, such that the first substrate and the first top plate form a single unit, thereby improving the structural stability of the first half part and ensuring the reaction in the first channel to be normally performed.

In some embodiments, the second half part includes a second substrate and a second top plate arranged opposite the second substrate, the second substrate is provided with the second bottom surface, and a second channel is formed between the second substrate and the second top plate.

In this way, the first half part and the second half part may have the same structure and adopt the same assembly method, featuring a simple operation.

In some embodiments, the second half part further includes a second connecting layer arranged between the second substrate and the second top plate, the second channel is formed on the second connecting layer, and the second channel penetrates through the second connecting layer in a thickness direction of the second connecting layer.

In this way, the second connecting layer can fixedly connect the second substrate and the second top plate, such that the second substrate and the second top plate form a single unit, thereby improving the structural stability of the second half part.

In some embodiments, the second half part includes a second substrate, a second top plate, and a second connecting layer arranged between the second substrate and the second top plate, the second substrate is provided with the second bottom surface, and the second connecting layer is a structurally continuous solid sheet.

In this way, the chip as a whole has a similar structural composition and can be adapted to current sequencing platforms, particularly to the structure of the carrying platform, without large structural adjustments. More importantly, the chip has dimensions equal to the combined size of the first half part and the second half part, but only the first half part is provided with the channel for the circulation and reaction of the reagent, that is, the flow channel is arranged in part of the area of the chip, such that the chip can meet the requirement for the number of the flow channels for a small amount or trace amount of samples. In addition, the design can increase the connection area of the connecting layer with the first substrate and the second top plate, thereby improving the structural stability of the second half part.

In some embodiments, the first connecting layer and the second connecting layer are of an integrated structure.

In this way, it facilitates the integrated processing and production of the first connecting layer and the second connecting layer, reducing the production cost of the sheet assembly.

In some embodiments, the first top plate and the second top plate are of a split structure.

In this way, it facilitates the disassembly and maintenance of the first top plate and the second top plate separately, reducing the maintenance cost of the chip.

In some embodiments, the first substrate and the second substrate are of a split structure.

In this way, it facilitates the disassembly and maintenance of the first substrate and the second substrate separately, reducing the maintenance cost of the chip.

In some embodiments, the chip includes a sealing member arranged on the first bottom surface, the sealing member being provided with a connecting hole communicating with the through hole.

In this way, the sealing member can improve the sealing performance of the connection between the chip and the external components, reducing the probability of leakage of the reagent solution.

In some embodiments, the second half part is a plate member of an integrated structure.

In this way, the second half part features a simple structure, thereby reducing the production process and the assembly process and lowering the production time and production cost of the chip.

In some embodiments, the chip includes a frame body, the frame body is provided with a window, and the first half part and the second half part are both fixed on the frame body and at least partially exposed through the window.

In this way, the frame body can serve as a supporting structure for the chip, reducing the external impact on the inside of the chip and improving the stability of the chip.

In some embodiments, an end part of the first channel in a length direction is in a converged state, and the through hole communicates with the end part of the first channel in the length direction thereof; when the chip is provided with a second channel, an end part of the second channel in a length direction is in a converged state, and the through hole communicates with the end part of the second channel in the length direction thereof.

In this way, it facilitates the dispersal of the reagent solution from the end part into the first channel and also facilitates the convergence of the reagent solution in the first channel toward the end part.

In some embodiments, there are a plurality of the first channels, and in two first channels on outer sides, end parts of the first channels in the length direction converge toward a direction close to each other; and/or there are a plurality of the second channels, and in two second channels on outer sides, end parts of the second channels in the length direction converge toward a direction close to each other.

In this way, the positions of the through holes at the outermost sides of the first half part and the second half part are moved inward. When the carrying platform is provided with a hole channel communicating with the through hole, the positions of the two hole channels at the outermost sides can be defined, thus narrowing the hole opening area on the carrying platform connected to the through hole. When the chip is combined with the carrying platform through vacuum adsorption, the adsorbable area of the chip and the carrying platform can be increased by the method, thus improving the adsorption effect of the carrying platform.

In some embodiments, there are a plurality of the first channels arranged in pairs, where in one pair of the first channels, end parts of the two first channels in the length direction converge toward the direction close to each other; and/or there are a plurality of the second channels arranged in pairs, where in one pair of the second channels, end parts of the two second channels in the length direction converge toward the direction close to each other.

In this way, the arrangement of the plurality of first channels in pairs can improve the uniformity of the first channels and thus improve the uniformity of the liquid inflow, enabling the operation of the liquid inflow to be convenient.

In some embodiments, in one pair of the first channels, the two first channels are symmetrically arranged in the length direction thereof; and/or in one pair of the second channels, the two second channels are symmetrically arranged in the length direction thereof.

In this way, the symmetrical arrangement of the paired first channels in the length direction of the first channels can enable better consistency when the fluid is injected into the first channels, which is beneficial for achieving a reaction result with better overall stability.

The method for manufacturing a chip according to the embodiments of the present disclosure includes:
providing a frame body; and
arranging a first half part and a second half part of a sheet assembly in parallel on the frame body along a width direction of the chip.

In this way, through the above steps, the first half part and the second half part can be arranged on the frame body to form the chip.

In some embodiments, the first half part is implemented by following steps:
providing a first substrate, a first connecting layer, and a first top plate; and
arranging the first connecting layer between the first substrate and the first top plate, and causing the first connecting layer to connect the first substrate and the first top plate.

In this way, the first connecting layer can connect and fix the first substrate and the first top plate, forming the first half part.

In some embodiments, arranging the first connecting layer between the first substrate and the first top plate includes:
placing the first substrate on a carrier platform;
placing the first connecting layer on a conveying apparatus;
driving the carrier platform and the conveying apparatus to move toward each other to cause the carrier platform and the conveying apparatus to be close to each other, thus driving the first connecting layer and the first substrate to be close to each other;
using a positioning apparatus to assist in positioning the first substrate and the first connecting layer;
controlling a laminating apparatus to attach the first connecting layer to the first substrate; and
attaching the first top plate to one side, facing away from the first substrate, of the first connecting layer.

In this way, by driving the conveying apparatus and the carrier platform to move toward each other and using the positioning apparatus to assist in the precise positioning of the first substrate and the first connecting layer, the attaching precision of the first connecting layer and the first substrate after being laminated by the laminating apparatus is improved, thus reducing the defect in the assembly of the first substrate and the first connecting layer.

In some embodiments, attaching the first top plate to the one side, facing away from the first substrate, of the first connecting layer includes:
placing the first top plate on the conveying apparatus;
driving the carrier platform and the conveying apparatus to move toward each other to cause the carrier platform and the conveying apparatus to be close to each other, thus driving the first substrate attached with the first connecting layer and the first top plate to be close to each other;
using the positioning apparatus to assist in positioning the first substrate attached with the first connecting layer and the first top plate; and
controlling the laminating apparatus to attach the first substrate attached with the first connecting layer to the first top plate.

In this way, by driving the conveying apparatus and the carrier platform to move toward each other and using the positioning apparatus to assist in the precise positioning of the first substrate attached with the first connecting layer and the first top plate, the attaching precision of the first substrate attached with the first connecting layer and the first top plate after being laminated by the laminating apparatus is improved, thus reducing the defect in the assembly of the first substrate attached with the first connecting layer and the first top plate.

In some embodiments, after controlling the laminating apparatus to attach the first substrate attached with the first connecting layer to the first top plate, the method further includes:
using a pressure holding device to maintain pressure of the first half part after the first substrate and the first top plate are attached; and
using a bubble removal device to remove bubbles on the first half part after pressure maintenance.

In this way, by performing the pressure maintenance and bubble removal on the first half part after the first substrate and the first top plate are attached, the adhesion between the first substrate and the first top plate can be increased and the structural stability of the first half part can be improved.

In some embodiments, the first substrate is implemented by following steps:
forming a plurality of the through holes on a wafer; and
cutting the wafer along a preset path to acquire a plurality of the first substrates.

In this way, by forming the through holes on the wafer first and then cutting the wafer along the preset path to acquire the first substrates, it can be determined whether the cutting path is the preset path based on the position of the through holes on the first substrates, which facilitates the adjustment of the cutting path in advance, improving the production yield of the first substrates, and thus reducing the production cost of the first substrates.

In some embodiments, the manufacturing method further includes:
providing a sealing member;
attaching a third connecting layer to the sealing member; and
attaching the sealing member attached with the third connecting layer to the first half part and the second half part, and causing part of connecting holes of the sealing member to communicate with the through hole.

In this way, the connecting hole can communicate the through hole with an external component, and the sealing member can seal the connection between the first substrate and the external components, reducing the probability of leakage of the reagent solution.

In some embodiments, arranging the first half part and the second half part of the sheet assembly in parallel on the frame body along the width direction of the chip includes:
attaching a fourth connecting layer to both ends of the first half part and the second half part; and
attaching the first half part and the second half part, which are attached with the fourth connecting layer, to the frame body.

In this way, the first half part and the second half part can be stably fixed on the frame body through the fourth connecting layer, improving the structural stability of the chip.

Additional aspects and advantages of the present disclosure will be partially provided in the following description, will partially become apparent from the following description, or will be learned through the practice of the present disclosure.

### BRIEF DESCRIPTION OF THE DRAWINGS

The aforementioned and/or additional aspects and advantages of the present disclosure will become apparent and easily understood from the description of the embodiments with reference to the following drawings, in which:

FIG. 1 is a schematic structural diagram of a chip according to embodiments of the present disclosure;

FIG. 2 is a schematic structural diagram of a chip according to embodiments of the present disclosure;

FIG. 3 is a schematic structural diagram of a chip according to embodiments of the present disclosure;

FIG. 4 is an exploded view of a chip according to embodiments of the present disclosure;

FIG. 5 is an exploded view of a chip according to embodiments of the present disclosure;

FIG. 6 is an exploded view of a chip according to embodiments of the present disclosure;

FIG. 7 is an exploded view of a chip according to embodiments of the present disclosure;

FIG. 8 is a flowchart of a method for manufacturing a chip according to embodiments of the present disclosure;

FIG. 9 is a flowchart of a method for manufacturing a chip according to embodiments of the present disclosure;

FIG. 10 is a flowchart of a method for manufacturing a chip according to embodiments of the present disclosure;

FIG. 11 is a schematic structural diagram of a device for manufacturing a first half part of a chip according to embodiments of the present disclosure;

FIG. 12 is a flowchart of a method for manufacturing a chip according to embodiments of the present disclosure;

FIG. 13 is a flowchart of a method for manufacturing a chip according to embodiments of the present disclosure;

FIG. 14 is a flowchart of a method for manufacturing a chip according to embodiments of the present disclosure;

FIG. 15 is a flowchart of a method for manufacturing a chip according to embodiments of the present disclosure; and

FIG. 16 is a flowchart of a method for manufacturing a chip according to embodiments of the present disclosure.

Description of the reference numerals: 100. sheet assembly; 10. first half part; 11. first channel; 111. middle section; 112. first end; 113. second end; 12. first bottom surface; 13. through hole; 14. first substrate; 15. first top plate; 16. first connecting layer; 20. second half part; 21. second bottom surface; 22. second substrate; 23. second top plate; 24. second connecting layer; 25. second channel; 200. sealing member; 210. connecting hole; 300. third connecting layer; 310. via hole; 400. frame body; 410. window; 500. fourth connecting layer; 1. chip; 2. carrier platform; 3. conveying apparatus; 4. positioning apparatus; 5. laminating apparatus.

### DETAILED DESCRIPTION

The embodiments of the present disclosure are described in detail below, and the examples of the embodiments are shown in the drawings, throughout which identical or similar reference numerals represent identical or similar elements or elements having identical or similar functionality. The embodiments described below with reference to the drawings are exemplary and are merely intended to illustrate the present disclosure, and should not be construed as limiting the present disclosure.

In the description of the present disclosure, it should be understood that orientational or positional relationships indicated by terms such as “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, or “counterclockwise”, are those shown on the basis of the drawings, and are merely intended to facilitate and simplify the description rather than indicate or imply that the indicated apparatus or element must have a specific orientation and be configured and operated according to the specific orientation. Such relationships should not be construed as limiting the present disclosure. In addition, the terms “first” and “second” are used herein for descriptive purposes only and should not be construed as indicating or implying relative importance or implicitly indicating the number of technical features described. Therefore, features defined with “first” and “second” may explicitly or implicitly include one or more of the features. In the description of the present disclosure, unless otherwise clearly and specifically defined, the term “plurality” means two or more.

In the description of the present disclosure, it should be noted that unless otherwise clearly specified and defined, the terms “mount”, “link”, and “connect” should be interpreted in their broad sense. For example, the connection may be a fixed connection, detachable connection, or integral connection; a mechanic connection, electric connection, or communicative connection; or a direct connection, indirect connection through an intermediate, internal communication of two elements, or interaction between two elements. For those of ordinary skill in the art, the specific meanings of the aforementioned terms in the present disclosure can be interpreted according to specific conditions.

In the present disclosure, unless otherwise clearly specified and defined, a first feature being “above” or “below” a second feature may include that the first and second features are in direct contact and that the first and second features are not in direct contact but are in contact via an additional feature between them. Moreover, a first feature being “on”, “over”, and “above” a second feature includes that the first feature is right above or obliquely above the second feature, or simply means that the first feature is at a vertically higher position than the second feature. A first feature being “under”, “beneath”, and “below” a second feature includes that the first feature is right below or obliquely below the second feature, or simply means that the first feature is at a vertically lower position than the second feature.

The length direction refers to the direction along the outer edge of a component where the dimension is relatively longer, and the width direction refers to the direction perpendicular to the length direction. Illustratively, in a chip that is rectangular as a whole, the direction of a long side in the outer edges of the rectangle is the length direction, and the direction of a short side perpendicular to the length direction is the width direction, that is, the direction of the short side is the width direction.

The following disclosure provides many different embodiments or examples for implementing different structures of the present disclosure. To simplify the disclosure of the present application, the components and settings of specific examples are described below. Certainly, the examples are merely exemplary and are not intended to limit the present disclosure. In addition, reference numerals and/or characters may be repeatedly used in different examples in the present disclosure for simplicity and clarity rather than to indicate the relationship between various embodiments and/or settings discussed. In addition, the present disclosure provides examples of various specific processes and materials, but those of ordinary skill in the art will recognize the application of other processes and/or the use of other materials.

In the present disclosure, the term “chip” is a reaction chamber provided with a space for containing a liquid and capable of fixing a sample under test. The chip is also referred to as a flow cell, a flow channel, or a flow chamber (Flowcell). In the field of sequencing, the term “chip” may also be referred to as a sequencing slide, a sequencing chip, or a biochip.

In the present disclosure, the term “sequencing” refers to sequence determination, and is used interchangeably with “nucleic acid sequencing” and “gene sequencing” to refer to the determination of base order in nucleic acid sequences, including sequencing by synthesis (SBS) and/or sequencing by ligation (SBL), including DNA sequencing and/or RNA sequencing, including long fragment sequencing and/or short fragment sequencing (the long fragment and short fragment are defined relatively; for example, nucleic acid molecules longer than 1 Kb, 2 Kb, 5 Kb, or 10 Kb may be referred to as long fragments, and nucleic acid molecules shorter than 1 Kb or 800 bp may be referred to as short fragments), and including double-end sequencing, single-end sequencing, paired-end sequencing, and/or the like (the double-end sequencing or paired-end sequencing may refer to the reading of any two segments or portions of the same nucleic acid molecule that are not completely overlapping).

The term “sequencing” includes the process of binding nucleotides (including nucleotide analogs) to a template and acquiring the corresponding reaction signals. Some sequencing platforms where the binding of nucleotides to the template and the acquisition of reaction signals are conducted asynchronously generally involve multiple cycles of sequencing to determine the order of multiple nucleotides/bases on the template. A “cycle of sequencing”, also referred to as “sequencing cycle”, may be defined as one base extension of the four nucleotides/bases, or in other words, as the determination process of the base type at any given position on the template. For sequencing platforms that achieve sequencing based on polymerization or ligation reactions, one cycle of sequencing includes the process of binding four nucleotides to the template at a time and acquiring the corresponding reaction signals. For platforms that achieve sequencing based on polymerization reaction, a reaction system includes reaction substrate nucleotides, a polymerase, and a template; a predetermined sequence (a sequencing primer) is bound to the template, and on the basis of the base pairing principle and the rationale of polymerization reaction, the added reaction substrate (nucleotides) is controllably connected to the 3′ end of the sequencing primer under the catalysis of the polymerase to achieve the pairing with the base at a corresponding position of the template. Generally, one cycle of sequencing may include one or more base extensions (repeats). For example, four nucleotides are sequentially added to the reaction system to each perform base extension and corresponding acquisition of reaction signals, and one cycle of sequencing includes four base extensions; for another example, four nucleotides are added into the reaction system in any combinations (such as in pairs or in one-three combinations), the two combinations each perform base extension and corresponding acquisition of reaction signals, and one cycle of sequencing includes two base extensions; for yet another example, four nucleotides are added simultaneously to the reaction system for base extension and reaction signal acquisition, and one cycle of sequencing includes one base extension.

Sequencing may be performed through a sequencing platform, which may be selected from, but is not limited to, the Hiseq/Miseq/Nextseq/Novaseq sequencing platform (Illumina), the Ion Torrent platform (Thermo Fisher/Life Technologies), the BGISEQ and MGISEQ/DNBSEQ platforms (BGI), and single-molecule sequencing platforms. The sequencing method may be selected from single-end sequencing and double-end sequencing.

The embodiments of the present disclosure provide a chip that can be used in the field of sequencing. Specifically, the chip can function as a substrate for carrying a nucleic acid template and meanwhile, provide a reaction place for base extension. However, it should be understood that gene sequencing is an application of the chip and is not intended to limit the application scope of the chip. The chip may also be used in other fields than sequencing, including, but not limited to, fields such as chemical molecule detection, protein detection, and enzyme detection. Different from the application for sequencing, when the chip is applied to other fields such as chemical molecule detection, protein detection, or enzyme detection, substances carried on the surface of the chip may be chemical molecules, biological molecules, proteins, enzymes, or the like which are different from nucleic acid molecules, and may also be nucleic acid molecules. In addition, the biochemical reactions occurring on the chip surface may also vary depending on the detection method.

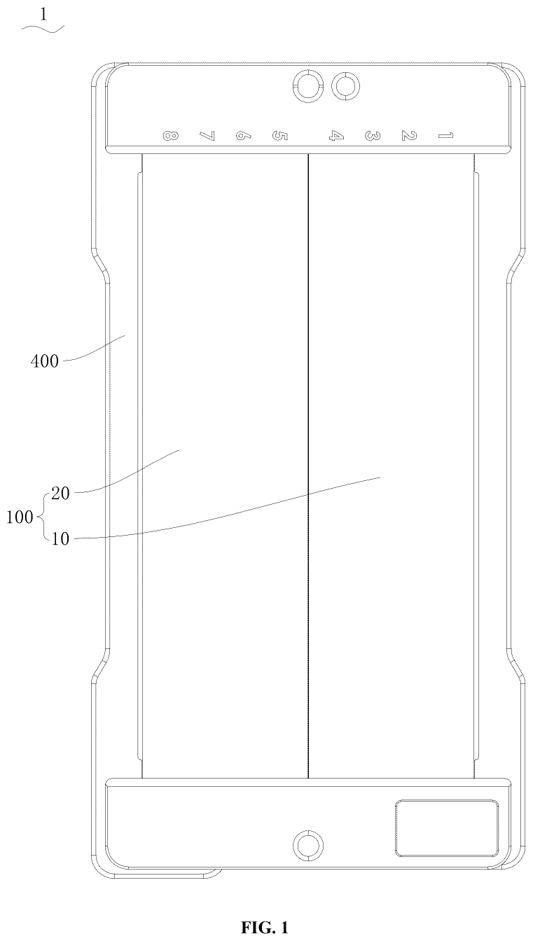

Referring to FIGS. 1 to 3, a chip 1 according to the embodiments of the present disclosure includes a sheet assembly 100. The sheet assembly 100 includes a first half part 10 and a second half part 20 arranged in parallel with the first half part 10 along the width direction of the chip 1. The first half part 10 is provided with a first channel 11.

The first half part 10 is provided with a first bottom surface 12. A through hole 13 that penetrates through the first bottom surface 12 and communicates with the first channel 11 is formed on the first half part 10. The second half part 20 is provided with a second bottom surface 21 flush with the first bottom surface 12. The second bottom surface 21 is a structurally continuous unbroken plane.

In this way, the reagent solution can enter the first channel 11 from the through hole 13 and circulate in the first half part 10 of the chip 1. The bottom surface of the second half part 20 is flush with the bottom surface of the first half part 10, which can reduce the likelihood of anomalies occurring when the first half part 10 and the second half part 20 are vacuum-adsorbed on the carrier platform. The second bottom surface 21 is a structurally continuous unbroken plane, which can prevent the reagent solution from entering the second half part 20 and serve to fill the chip 1, thus realizing the purpose of small-amount sequencing while the chip 1 is adapted to the carrier platform.

Specifically, the sheet assembly 100, as a main component structure of the chip 1, is configured to carry samples under test. Taking the sequencing chip 1 as an example, the sheet assembly 100 can carry nucleic acid molecules under test, provide a reaction place for the reaction on the surface of the chip 1, and meanwhile, provide a channel for the reagent solution participating in the reaction.

In the embodiments of the present disclosure, the sheet assembly 100 is an assembly formed by stacking a plurality of sheet-like parts. In the embodiments of the present disclosure, “stacking” means that the plurality of sheet-like parts have a common contact surface between each two sheet-like parts but do not enter each other. The contact surfaces of the plurality of sheet-like parts are bonded together to form the sheet assembly 100.

The number of the sheet-like parts is greater than or equal to two, that is, the sheet assembly 100 is formed by stacking at least two sheet-like parts. In different implementations, the number of the sheet-like parts may be designed according to the material and thickness of the sheet assembly 100. When there are two sheet-like parts, two layers of the sheet-like parts are arranged in a stacking manner to form the sheet assembly 100, and function as the sheet assembly 100 described above.

The overall shape of the sheet assembly 100 may be configured into a shape matching other structures of the chip 1. Illustratively, the overall shape of the sheet assembly 100 may be rectangular, square, rhomboidal, other polygonal shapes, or irregular shapes with arc-shaped circumferences. In some embodiments, the overall shape of the sheet assembly 100 is configured into a rectangle to match the structures for accommodating and fixing the chip 1 in most sequencing platform instruments.

The material of the sheet assembly 100 includes a glass material to enable the sheet assembly 100 to meet the requirements for surface evenness. Certainly, the material of the sheet assembly 100 may also include at least one of silicon dioxide, crystal, and quartz glass, or plastic, ceramic, polyethylene terephthalate (PET), polymethyl methacrylate (PMMA), or any other suitable material. It can be understood that at least one of the plurality of sheet-like parts making up the sheet assembly 100 is made of one of the materials described above. In some embodiments, one sheet-like part is made of one of the materials described above. Illustratively, the sheet-like parts are silicon dioxide layers, crystal layers, quartz glass layers, and the like.

The first half part 10 is provided with at least one first channel 11. The first channel 11 is a channel for the reagent solution to circulate in the chip 1. In the embodiments of the present disclosure, the first channel 11 can also fix the sample under test. Taking the sequencing chip 1 as an example, the nucleic acid molecule under test is immobilized in the first channel 11. When a reagent solution flows through the first channel 11, the reagent solution reacts with the nucleic acid molecule under test. Therefore, the first channel 11 also provides a reaction place for the reaction on the surface of the chip 1.

The first channel 11 is formed between two adjacent sheet-like parts. In areas outside the first channel 11, the two adjacent sheet-like parts may be bonded, for example, one of the sheet-like parts forms a protrusion in the thickness direction to bond with the other sheet-like part, or a layer of material such as channel glue may be filled in to form the bond. The first channel 11 may have an irregular shape.

In some embodiments, the first channel 11 may be identified by a code. The code may be placed on either end of the first channel 11 or placed on both ends of the first channel 11 to identify the channel. The type of the code includes, but is not limited to, a numeric code, an alphabetic code, a symbolic code, or a combination thereof.

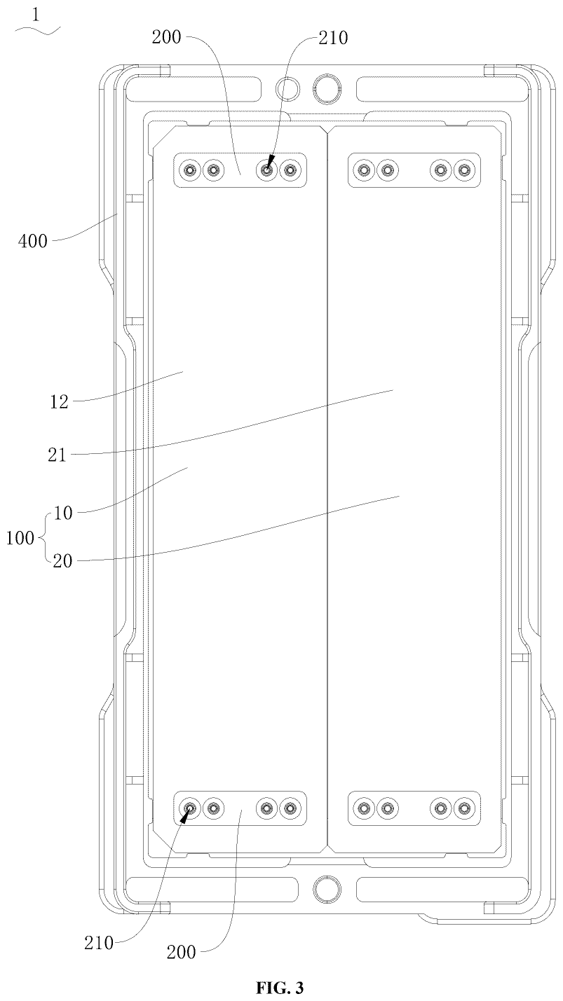

Referring to FIGS. 1 and 3, in some embodiments, the first half part 10 and the second half part 20 are of a split structure.

In this way, it facilitates the disassembly and maintenance of the first half part 10 and the second half part 20 separately, reducing the maintenance cost of the chip 1.

Specifically, the first half part 10 and the second half part 20 can be split into two separate parts. The thickness of the first half part 10 and the thickness of the second half part 20 are equal, such that the bottom surfaces and the top surfaces of both the first half part 10 and the second half part 20 form a uniform plane.

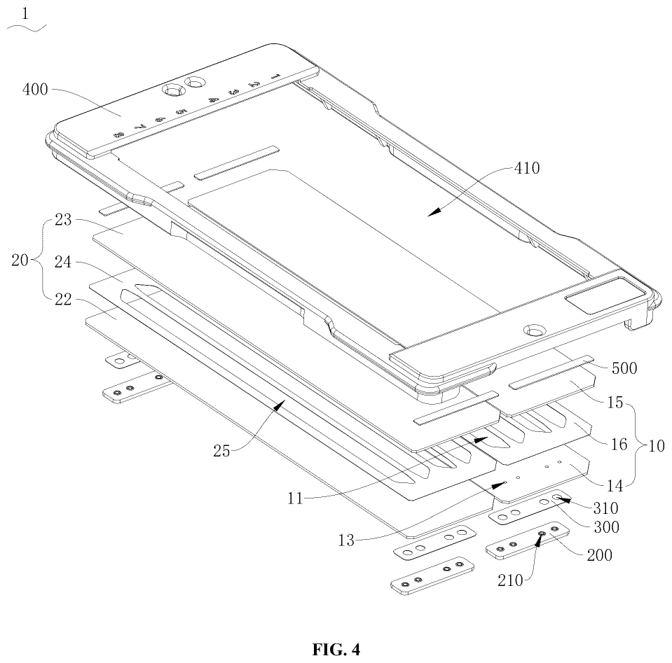

Referring to FIGS. 3 and 4, in some embodiments, the first half part 10 includes a first substrate 14 and a first top plate 15 arranged opposite the first substrate 14. The first channel 11 is formed between the first substrate 14 and the first top plate 15. The first substrate 14 is provided with a first bottom surface 12 and a through hole 13 is formed on the first substrate.

In this way, the first channel 11 formed between the first substrate 14 and the first top plate 15 allows the reagent solution to circulate in the first half part 10; the through hole 13 allows the fluid such as the reagent solution to flow from the through hole 13 into the first channel 11 and flow out from the through hole 13 after reaction.

Specifically, the material of the first substrate 14 may include at least one of silicon dioxide, crystal, and quartz glass. It may also include at least one of plastic, ceramic, polyethylene terephthalate (PET), and polymethyl methacrylate (PMMA). Additionally, the material may be a composite material made from at least one of silicon dioxide, crystal, and quartz glass, combined with at least one of plastic, ceramic, polyethylene terephthalate (PET), and polymethyl methacrylate (PMMA). It can be understood that the first substrate 14 is made of one or more of the materials described above. In some embodiments, the first substrate 14 is made of one of the materials described above. Illustratively, the first substrate 14 is a silicon dioxide substrate, a crystal substrate, a quartz glass substrate, and the like. Certainly, the first substrate 14 may also be formed by stacking a plurality of substrate units made of the same or different materials. In the embodiment, the stacking manner may involve stacking sequentially in a direction perpendicular to one surface of the substrate unit, or stacking sequentially in a direction parallel to one surface of the substrate unit. Illustratively, the first substrate 14 is a composite substrate, including a silicon dioxide substrate unit and a quartz glass layer formed on the surface of one side of the silicon dioxide substrate unit. When the first substrate 14 includes a plurality of substrate units, the number of substrate units is not strictly limited and may be adjusted according to the intended size, such as thickness, of the first substrate 14.

In the embodiments of the present disclosure, the shape of the first substrate 14 may be rectangular, square, rhomboidal, other polygonal shapes, or irregular shapes with arc-shaped circumferences. In some embodiments, the overall shape of the first substrate 14 is configured into a rectangle to fit the structures for receiving and fixing the chip 1 in most sequencing platform instruments.

In the embodiments of the present disclosure, as shown in FIGS. 3 and 4, the first substrate 14 is a rectangle. The first substrate 14 includes through holes 13 provided on both ends in the length direction and penetrating through the first substrate 14 in the thickness direction.

In the embodiments of the present disclosure, the number of the through holes 13 on one end of the first substrate 14 in the length direction corresponds to the number of the first channels 11 provided on the chip 1. The shape of the through hole 13 is not strictly limited. It may be a square hole, a circular hole, or any other type of hole, which is not specifically limited in the present disclosure. Illustratively, the through hole 13 is a circular hole. In this case, it can be understood that the cross-section of the through hole 13 in the planar direction of the first substrate 14 has a circular shape.

The shape of the first top plate 15 may be square, rectangular, rhomboidal, circular, triangular, or various other regular shapes. Certainly, the first top plate 15 may also have an irregular shape. In one embodiment, the first top plate 15 is a rectangle. In some embodiments, the shape of the first top plate 15 is the same as the shape of the first substrate 14. In some embodiments, the first top plate 15 is provided with a shape exactly the same as that of the first substrate 14.

In some embodiments, the area of the first top plate 15 is smaller than the area of the first substrate 14. For example, in the length and/or width direction of the first half part 10, both ends of the first top plate 15 are indented toward the middle area, such that both ends of the first half part 10 in the length and/or width direction are left empty relative to the first top plate 15.

In some embodiments, the thickness of the first top plate 15 is smaller than the thickness of the first substrate 14.

In one embodiment, the first half part 10 includes a first top plate 15, and the first top plate 15 is bonded to one surface of the first substrate 14. In another embodiment, the first half part 10 includes two first top plates 15, and the two first top plates 15 are respectively bonded to two surfaces of the first substrate 14, that is, the upper surface and the lower surface of the first substrate 14 are respectively covered by the first top plates 15.

The first top plate 15 may be made of, for example, glass, silicon dioxide, crystal, quartz glass, plastic, ceramic, polyethylene terephthalate (PET), polymethyl methacrylate (PMMA), or any other suitable material. It should be understood that at least one of the first substrate 14 and the first top plate 15 is selected from a light-transmitting material, which includes, but is not limited to, glass and crystal.

In one embodiment, the first substrate 14 and/or the first top plate 15 are selected from a light-transmitting material, such that the optical system can acquire the optical signals generated on the surface of the chip 1. Therefore, the types of reactions that occur on the surface of the chip 1, particularly in the first half part 10, can be expanded to optical application levels. As in the sequencing chip 1, when a substrate having a fluorescent group is used to react with a nucleic acid molecule immobilized on the surface of the chip 1, particularly on the surface of the first half part 10, the optical system acquires the optical signals generated via the fluorophore on the surface of the first half part 10 to determine the reaction site and the type of the substrate.

Certainly, it can be understood that the first substrate 14 and the first top plate 15 are both sheet-like parts made of a light-transmitting material, and the first half part 10 is subjected to a light-shielding treatment on the side where light transmission is not required. In some embodiments, for the chip 1 used for sequencing, when the laser light emitted from the laser of the sequencing platform is irradiated through the lens onto the chip 1, particularly in the first channel 11, it is also irradiated onto the material connecting the first substrate 14 to the first top plate 15, such as the glue layer, and the molecules of the glue layer are accordingly excited to emit fluorescence, thereby greatly interfering with the identification and detection of the target signal, i.e., the signal from the nucleic acid molecule under test in the first channel 11. To avoid such interference, the first substrate 14 is subjected to a light-shielding treatment. The light-shielding treatment can be achieved in various methods, such as forming a light-shielding coating on the first bottom surface 12 to satisfy the requirements of gene sequencers, particularly single-molecule sequencers, for the fluorescent background characteristics of the chip 1. The first bottom surface 12 is the surface of the first substrate 14 facing away from the first top plate 15.

In some embodiments, the material of the first substrate 14 and/or the first top plate 15 includes glass. In this way, the glass material of the first substrate 14 and/or the first top plate 15 enables a better fluidity of the liquid, and thus the liquid is less likely to adhere to the inside of the chip 1, improving the detection accuracy of the chip 1. Specifically, the glass is an amorphous inorganic non-metallic material and is generally manufactured by using various inorganic minerals, such as quartz sand, borax, boric acid, barite, barium carbonate, limestone, feldspar, and soda ash as main raw materials and adding a small amount of auxiliary raw materials. The main components of the glass are silicon dioxide and other oxides.

Referring to FIG. 4, in some embodiments, the first half part 10 further includes a first connecting layer 16 arranged between the first substrate 14 and the first top plate 15. A first channel 11 is formed on the first connecting layer 16. The first channel 11 penetrates through the first connecting layer 16 in the thickness direction of the first connecting layer 16.

In this way, the first connecting layer 16 can fixedly connect the first substrate 14 and the first top plate 15, such that the first substrate 14 and the first top plate 15 form a single unit, thereby improving the structural stability of the first half part 10 and ensuring the reaction in the first channel 11 to be normally performed.

Specifically, the first connecting layer 16 is bonded to the surface of at least one side of the first substrate 14, such that the thickness direction of the first connecting layer 16 is perpendicular to the surface of the first substrate 14. It should be understood that the bonding of the first connecting layer 16 to the surface of at least one side of the first substrate 14 includes two situations. Specifically, in the first situation, the first connecting layer 16 is bonded to one surface of the first substrate 14, and in this case, the sample under test is fixed to the surface of the first substrate 14 on which the first connecting layer 16 is arranged; more specifically, the sample under test is fixed in the area of the first substrate 14 surface that is not bonded with the material of the first connecting layer 16. In the second situation, the first connecting layer 16 is bonded to two opposite surfaces of the first substrate 14, and in this case, both surfaces of the first substrate 14 on which the first connecting layer 16 is arranged, specifically the areas of the first substrate 14 that are not boned with the material of the first connecting layer 16, may be bonded with the sample under test. This method allows for sequencing on the upper surface and the lower surface of one chip 1 and even enables simultaneous sequencing on the two surfaces.

In one embodiment, the area of the first connecting layer 16 is smaller than the area of the first substrate 14. As an example, in the length and/or width direction of the first half part 10, both ends of the first connecting layer 16 are indented toward the middle area, such that both ends of the first substrate 14 in the length and/or width direction are left empty, i.e., both ends of the first substrate 14 in the length and/or width direction are not bonded with the first connecting layer 16.

In another embodiment, the outer edge shape and size of the first connecting layer 16 is the same as the outer edge shape and size of the first top plate 15.

In some embodiments, the material of the first connecting layer 16 may include at least one of epoxy resin in epoxy adhesive, acrylic resin in acrylate adhesive, optical clear adhesive (OCA), pressure sensitive adhesive (PSA), polyimide (PI) double-sided adhesive, and the like. Therefore, the first connecting layer 16 may be bonded, through its adhesive property, to the surface of at least one side of the first substrate 14. Specifically, the first connecting layer 16 can adhere the first substrate 14 to the first top plate 15. In this way, the first substrate 14 and the first top plate 15 are connected through adhesion, such that the first substrate 14 is fixedly connected to the first top plate 15.

In some embodiments, the material of the first connecting layer 16 may include other materials with a surface-formed glue layer, such as PE foam double-sided adhesive. In this case, the first connecting layer 16 may adhere to the surface of at least one side of the first substrate 14 via the surface-formed glue layer. It should be understood that the surface-formed glue layer may be arranged on part of the area where the first connecting layer 16 is bonded with the first substrate 14. Alternatively, the adhesive material may be arranged on the entire area where the first connecting layer 16 is bonded with the first substrate 14. In one embodiment, the adhesive material is arranged on the entire area where the first connecting layer 16 is bonded with the first substrate 14, such that the risk of cross-channel flow of the reaction reagent solution or solutions in different flow channels can be reduced, and the influence on the accuracy of the detection result is further reduced. In addition, by fully adhering the first connecting layer 16 to the first substrate 14, the infiltration of the reagent solution into unadhered areas can be reduced, thereby reducing the loss of the reagent solution.

Referring to FIG. 4, in some embodiments, the second half part 20 includes a second substrate 22 and a second top plate 23 arranged opposite the second substrate 22. The second substrate 22 is provided with a second bottom surface 21. A second channel 25 is formed between the second substrate 22 and the second top plate 23.

In this way, the first half part 10 and the second half part 20 may have the same structure and adopt the same assembly method, featuring a simple operation.

Specifically, the material of the second substrate 22 may include at least one of silicon dioxide, crystal, and quartz glass. It may also include at least one of plastic, ceramic, polyethylene terephthalate (PET), and polymethyl methacrylate (PMMA). Additionally, the material may be a composite material from at least one of silicon dioxide, crystal, and quartz glass, combined with at least one of plastic, ceramic, polyethylene terephthalate (PET), and polymethyl methacrylate (PMMA). It can be understood that the second substrate 22 is made of one or more of the materials described above. In some embodiments, the second substrate 22 is made of one of the materials described above. Illustratively, the second substrate 22 is a silicon dioxide substrate, a crystal substrate, a quartz glass substrate, or the like. Certainly, the second substrate 22 may be formed by stacking a plurality of substrate units made of the same or different materials. In the embodiment, the stacking manner may involve stacking sequentially in a direction perpendicular to one surface of the substrate unit, or stacking sequentially in a direction parallel to one surface of the substrate unit. Illustratively, the second substrate 22 is a composite substrate, including a silicon dioxide substrate unit and a quartz glass layer formed on the surface of one side of the silicon dioxide substrate unit. When the second substrate 22 includes a plurality of substrate units, the number of substrate units is not strictly limited and may be adjusted according to the intended size, such as thickness, of the second substrate 22.

In the embodiments of the present disclosure, the shape of the second substrate 22 may be rectangular, square, rhomboidal, other polygonal shapes, or irregular shapes with arc-shaped circumferences. In some embodiments, the overall shape of the second substrate 22 is configured into a rectangle to fit the structures for accommodating and fixing the chip 1 in most sequencing platform instruments.

The shape of the second top plate 23 may be square, rectangular, rhomboidal, circular, triangular, or various other regular shapes. Certainly, the second top plate 23 may also have an irregular shape. In one embodiment, the second top plate 23 is a rectangle. In some embodiments, the shape of the second top plate 23 is the same as the shape of the second substrate 22. In some embodiments, the second top plate 23 is provided with a shape exactly the same as that of the second substrate 22.

In some embodiments, the area of the second top plate 23 is smaller than the area of the second substrate 22. For example, in the length and/or width direction of the second half part 20, both ends of the second top plate 23 are indented toward the middle area, such that both ends of the second half part 20 in the length and/or width direction are left empty relative to the second top plate 23.

In some embodiments, the thickness of the second top plate 23 is smaller than the thickness of the second substrate 22.

In one embodiment, the second half part 20 includes one second top plate 23, and the second top plate 23 is bonded to one surface of the second substrate 22. In another embodiment, the second half part 20 includes two second top plates 23, and the two second top plates 23 are respectively bonded to two surfaces of the second substrate 22, that is, the upper surface and the lower surface of the second substrate 22 are respectively covered by the second top plates 23.

The second top plate 23 may be made of, for example, glass, silicon dioxide, crystal, quartz glass, plastic, ceramic, polyethylene terephthalate (PET), polymethyl methacrylate (PMMA), or any other suitable material.

In some embodiments, the material of the second substrate 22 and/or the second top plate 23 includes glass. Specifically, the glass is an amorphous inorganic non-metallic material and is generally manufactured by using various inorganic minerals, such as quartz sand, borax, boric acid, barite, barium carbonate, limestone, feldspar, and soda ash as main raw materials and adding a small amount of auxiliary raw materials. The main components of the glass are silicon dioxide and other oxides.

Referring to FIG. 4, in some embodiments, the second half part 20 further includes a second connecting layer 24 arranged between the second substrate 22 and the second top plate 23. A second channel 25 is formed on the second connecting layer 24. The second channel 25 penetrates through the second connecting layer 24 in the thickness direction of the second connecting layer 24. In some embodiments, the second channel 25 may be identified by a code. The code may be placed on either end of the second channel 25 or placed on both ends of the second channel 25 to identify the channel. The type of the code includes, but is not limited to, a numeric code, an alphabetic code, a symbolic code, or a combination thereof. The code of the second channel 25 may be continuous with the code of the first channel 11 or may be independent of the code of the first channel.

In this way, the second connecting layer 24 can fixedly connect the second substrate 22 and the second top plate 23, such that the second substrate 22 and the second top plate 23 form a single unit, thereby improving the structural stability of the second half part 20.

Specifically, in one embodiment, the area of the second connecting layer 24 is smaller than the area of the second substrate 22. As an example, in the length and/or width direction of the second half part 20, both ends of the second connecting layer 24 are indented toward the middle area, such that both ends of the second substrate 22 in the length and/or width direction are left empty, i.e., both ends of the second substrate 22 in the length and/or width direction are not bonded with the second connecting layer 24. In another embodiment, the outer edge shape and size of the second connecting layer 24 is the same as the outer edge shape and size of the second top plate 23.

In some embodiments, the material of the second connecting layer 24 may include at least one of epoxy resin in epoxy adhesive, acrylic resin in acrylate adhesive, optical clear adhesive (OCA), pressure sensitive adhesive (PSA), polyimide (PI) double-sided adhesive, and the like. Therefore, the second connecting layer 24 may be bonded, through its adhesive property, to the surface of at least one side of the second substrate 22. Specifically, the second connecting layer 24 can adhere the second substrate 22 to the second top plate 23. In this way, the second substrate 22 and the second top plate 23 are connected through adhesion, such that the second substrate 22 is fixedly connected to the second top plate 23.

In some embodiments, the material of the second connecting layer 24 may include other materials with a surface-formed glue layer, such as PE foam double-sided adhesive. In this case, the second connecting layer 24 may adhere to the surface of at least one side of the second substrate 22 via the surface-formed glue layer. It should be understood that the surface-formed glue layer may be arranged on part of the area where the second connecting layer 24 is bonded with the second substrate 22. Alternatively, the adhesive material may be arranged on the entire area where the second connecting layer 24 is bonded with the second substrate 22.

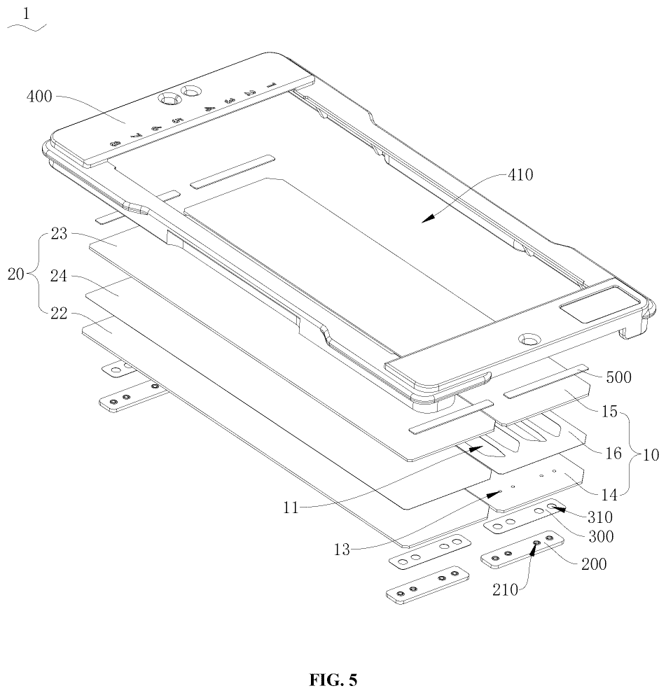

Referring to FIG. 5, in some embodiments, the second half part 20 includes a second substrate 22, a second top plate 23, and a second connecting layer 24 arranged between the second substrate 22 and the second top plate 23. The second substrate 22 is provided with a second bottom surface 21. The second connecting layer 24 is a structurally continuous solid sheet.

In this way, the chip 1 as a whole has a similar structural composition and can be adapted to current sequencing platforms, particularly to the structure of the carrying platform, without large structural adjustment. More importantly, the chip 1 has dimensions equal to the combined size of the first half part 10 and the second half part 20, but only the first half part 10 is provided with the channel for the circulation and reaction of the reagent, that is, the flow channel is arranged in part of the area of the chip 1, such that the chip can meet the requirement for the number of the flow channels for a small amount or trace amount of samples. In addition, the design can increase the connection area of the connecting layer with the first substrate 14 and the second top plate 23, thereby improving the structural stability of the second half part 20.

Specifically, all surfaces of the second connecting layer 24 are provided with the adhesive material. The size of the second connecting layer 24 may be smaller than or equal to the size of the second substrate 22 and the size of the second top plate 23, such that the second substrate 22 and the second top plate 23 can adhere to all surfaces of the second connecting layer 24.

In some embodiments, the second connecting layer 24 is made of the same material as the first connecting layer 16, except that the second connecting layer 24 does not form a hollow area corresponding to the first channel 11.

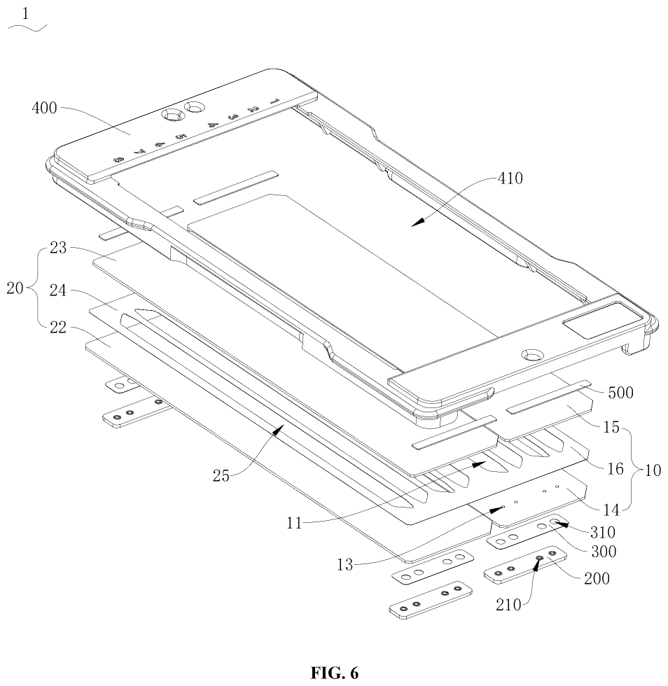

Referring to FIG. 6, in some embodiments, the first connecting layer 16 and the second connecting layer 24 are of an integrated structure.

In this way, it facilitates the integrated processing and production of the first connecting layer 16 and the second connecting layer 24, reducing the production cost of the sheet assembly 100.

Specifically, the first connecting layer 16 and the second connecting layer 24 may be integrally formed. In one embodiment, the first connecting layer 16 and the second connecting layer 24 are of a split structure, i.e., the first connecting layer 16 and the second connecting layer 24 are made separately. The first connecting layer 16 and the second connecting layer 24 may be of the same structure, i.e., the first connecting layer 16 and the second connecting layer 24 both have channels formed thereon, and the first connecting layer 16 and the second connecting layer 24 may be used interchangeably. Alternatively, the first connecting layer 16 has the first channel 11 formed thereon, and the second connecting layer 24 is a structurally continuous solid sheet.

Referring to FIG. 6, in some embodiments, the first top plate 15 and the second top plate 23 are of a split structure.

In this way, it facilitates the disassembly and maintenance of the first top plate 15 and the second top plate 23 separately, reducing the maintenance cost of the chip 1.

Specifically, the first top plate 15 and the second top plate 23 may be made of the same material and manufactured to have the same size, or in other words, the first top plate 15 and the second top plate 23 may be used interchangeably, or the first top plate 15 and the second top plate 23 may be of the same structure.

In some embodiments, the first top plate 15 and the second top plate 23 are of an integrated structure, i.e., integrally formed.

Referring to FIG. 6, in some embodiments, the first substrate 14 and the second substrate 22 are of a split structure.

In this way, it facilitates the disassembly and maintenance of the first substrate 14 and the second substrate 22 separately, reducing the maintenance cost of the chip 1.

Specifically, the first substrate 14 and the second substrate 22 may be made of the same material and manufactured to have the same size, except that the first substrate 14 has a through hole 13 communicating with the first channel 11 formed thereon, and the second substrate 22 is a structurally continuous solid sheet.

In some embodiments, the first substrate 14 and the second substrate 22 are of an integrated structure, i.e., integrally formed.

It should be understood that when the second half part 20 includes a plurality of layer structures, it may be one of the layer structures that is integrally designed with part of the structure of the first half part 10, or it may be each of the layer structures individually integrally designed with each of the layer structures of the first half part 10.

Referring to FIG. 7, in some embodiments, the second half part 20 is a plate member of an integrated structure.

In this way, the second half part 20 features a simple structure, thereby reducing the production process and the assembly process and lowering the production time and production cost of the chip 1.

Specifically, the second half part 20 may include any suitable material, such as glass, silicon dioxide, crystal, quartz glass, plastic, ceramic, polyethylene terephthalate (PET), polymethyl methacrylate (PMMA), or any other suitable material.

The shape of the second half part 20 may be square, rectangular, circular, triangular, or various other regular shapes. Certainly, the second half part 20 may also have an irregular shape. In the embodiment, the second half part 20 is a long rectangle.

Optionally, the material of the second half part 20 includes glass. The glass is an amorphous inorganic non-metallic material and is generally manufactured by using various inorganic minerals, such as quartz sand, borax, boric acid, barite, barium carbonate, limestone, feldspar, and soda ash as the main raw materials and adding a small amount of auxiliary raw materials. The main components of the glass are silicon dioxide and other oxides.

Referring to FIGS. 3 and 6, in some embodiments, the chip 1 includes a sealing member 200 arranged on the first bottom surface 12. The sealing member 200 is provided with a connecting hole 210 communicating with the through hole 13.

In this way, the sealing member 200 can improve the sealing performance of the connection between the chip 1 and the external components, reducing the probability of leakage of the reagent solution.

Specifically, the sealing member 200 may be an element of elasticity, such as a rubber. The sealing member 200 may be fixedly connected to the first bottom surface 12 through a third connecting layer 300. The third connecting layer 300 includes, but is not limited to, a water-based adhesive and a double-sided adhesive. The shape and size of the third connecting layer 300 may be adapted to match the sealing member 200. A via hole 310 that matches the connecting hole 210 is formed on the third connecting layer 300, and the central axis of the via hole 310 is coaxially arranged with the central axis of the connecting hole 210. The connecting hole 210 may be a cylindrical through hole 13. The connecting hole 210 communicates the external components with the through hole 13 to enable the reagent solution to flow from the external components to the first channel 11 and enable the reagent solution to flow from the first channel 11 into the external components. The central axis of the connecting hole 210 is coaxially arranged with the central axis of the through hole 13. The sealing member 200 may have a cylindrical shape with one connecting hole 210 formed on one sealing member 200, and the sealing member 200 is arranged in one-to-one correspondence with the through hole 13. The sealing member 200 may also have a rectangular-parallelepiped shape with a plurality of connecting holes 210 formed on one sealing member 200, and the one sealing member 200 is arranged in correspondence with a plurality of through holes 13.

Referring to FIGS. 1 and 4, in some embodiments, the chip 1 includes a frame body 400. The frame body 400 is provided with a window 410. The first half part 10 and the second half part 20 are both fixed on the frame body 400 and at least partially exposed through the window 410.

In this way, the frame body 400 can serve as a supporting structure for the chip 1, reducing the external impact on the inside of the chip 1 and improving the stability of the chip 1.

Specifically, the frame body 400 is the outermost layer of the chip 1 and serves to protect the chip 1. The frame body 400 encloses the sheet assembly 100 of the chip 1 and provides a carrier for the reagent solution. The frame body 400 is arranged on one side, distal to the first substrate 14, of the first top plate 15, facilitating the removal and placement of the sheet assembly 100. Moreover, this prevents direct contact with the sheet assembly 100, which could leave fingerprints or other residues on the surface of the chip 1, affecting the acquisition of the optical signals generated in the chip 1. Furthermore, through the configuration of the structure of the frame body 400, the chip 1 can be fixed on a specific area of the testing instrument to detect the sample under test fixed in the chip 1. For example, the chip 1 is fixed on the surface of the carrying platform of the chip 1 of the sequencing platform to enable stable sequencing. The frame body 400 may be made of resin. The frame body 400 is formed by using an injection molding process, such that the manufacturing cost is low and the manufacturing process is simple. The first half part 10 and the second half part 20 may be fixedly connected to the surface of the frame body 400 through a fourth connecting layer 500. The fourth connecting layer 500 includes, but is not limited to, a water-based adhesive and a double-sided adhesive.

The window 410 is configured for the imaging system to image the interior of the first channel 11 through the window 410. The window 410 may be a hollow structure, and the shape of the window 410 includes, but is not limited to, an elliptical shape, a rectangular shape, or the like.

Both ends of the frame body 400 may be provided with codes for identifying the channel and/or the chip 1. The position of the codes is not strictly limited and may be flexibly set. Illustratively, the codes for identifying the channel may be set at one end of the frame body 400, and the codes for identifying the chip 1 may be set on the other end of the frame body 400.

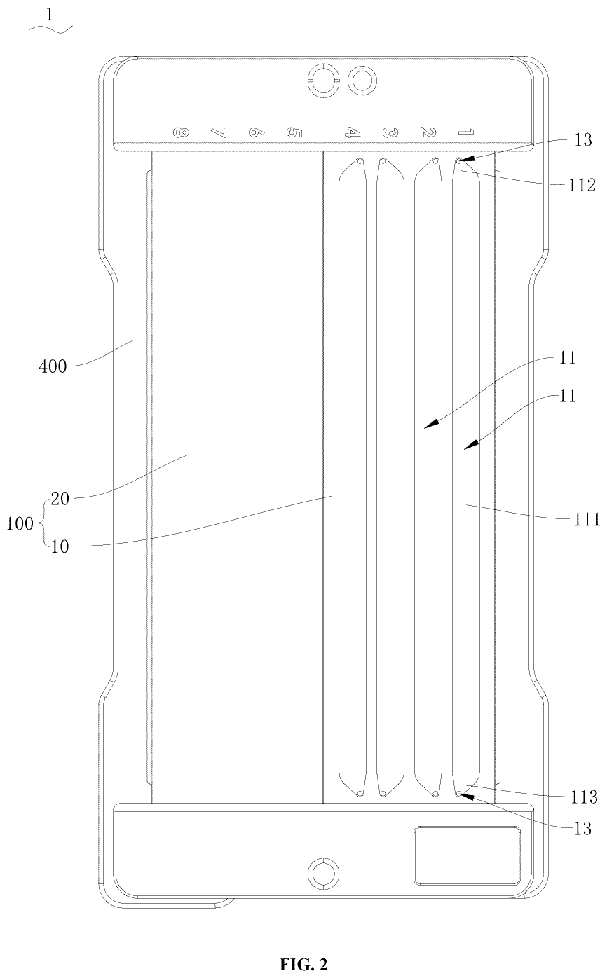

Referring to FIG. 2, in some embodiments, the end part of the first channel 11 in the length direction is in a converged state, and the through hole 13 communicates with the end part of the first channel 11 in the length direction thereof. When the chip 1 is provided with the second channel 25, the end part of the second channel 25 in the length direction is in a converged state, and the through hole communicates with the end part of the second channel 25 in the length direction thereof.

In this way, it facilitates the dispersal of the reagent solution from the end part into the first channel 11 and also facilitates the convergence of the reagent solution in the first channel 11 toward the end part.

Specifically, the first channel 11 may have an irregular shape. For example, the first channel 11 may include a middle section 111, a first end 112, and a second end 113. The first end 112 and the second end 113 are respectively located at two ends of the first channel 11 and symmetrically arranged; the first end and the second end are both in a triangular shape, and the middle section 111 is in a long and narrow rectangular shape. Certainly, the first end 112 and the second end 113 may also have different shapes. For example, the first end 112 forms an included angle, and the second end 113 forms a round angle.

The first end 112, the middle section 111, and the second end 113 are sequentially arranged in the length direction of the first half part 10. The middle section 111 is configured for the reagent solution to undergo the corresponding reaction; the first end 112 may be configured as a liquid inlet area for the reagent solution to flow into the first channel 11; the second end 113 may be configured as a liquid outlet area for the reagent solution to flow out of the first channel 11. Certainly, it should be understood that the positions of the first end 112 and the second end 113 may be interchanged. Therefore, the first channel 11 may also be configured such that the second end 113 is a liquid inlet area for the reagent solution to flow into the first channel 11, and the first end 112 is a liquid outlet area for the reagent solution to flow out of the first channel 11. The shape and size of the second channel 25 may be the same as the shape and size of the first channel 11.

Referring to FIG. 2, in some embodiments, there are a plurality of first channels 11, and in the two first channels 11 on the outer sides, the end parts of the first channels 11 in the length direction converge toward the direction close to each other; and/or there are a plurality of second channels 25, and in the two second channels 25 on the outer sides, the end parts of the second channels 25 in the length direction converge toward the direction close to each other.

In this way, the positions of the through holes 13 on the outermost sides of the first half part 10 and the second half part 20 are moved inward. When forming hole channels communicating with the through holes 13 on the carrying platform, the positions of the two hole channels on the outermost sides can be defined, thus narrowing the opening area connected to the through hole 13 on the carrying platform. When the chip 1 is combined with the carrying platform through vacuum adsorption, the adsorbable area of the chip 1 and the carrying platform can be increased by the method, thus improving the adsorption effect of the carrying platform.

Specifically, there may be two, three, four, five, or more first channels 11. In one embodiment, there are three first channels 11. The end part of the first of the first channels 11 and the end part of the third of the first channels 11 are close to each other.

There may be two, three, four, five, or more second channels 25. In one embodiment, there are three second channels 25. The end part of the first of the second channels 25 and the end part of the third of the second channels 25 are close to each other.

It may be that there are a plurality of first channels 11, and in the two first channels 11 on the outer sides, the end parts of the first channels 11 in the length direction converge toward the direction close to each other. Alternatively, it may be that there are a plurality of second channels 25, and in the two second channels 25 on the outer sides, the end parts of the second channels 25 in the length direction converge toward the direction close to each other. Or, it may be that there are a plurality of first channels 11 and a plurality of second channels 25, where in the two first channels 11 on the outer sides, the end parts of the first channels 11 in the length direction converge toward the direction close to each other, and in the two second channels 25 on the outer sides, the end parts of the second channels 25 in the length direction converge toward the direction close to each other.

Referring to FIG. 2, in some embodiments, there are a plurality of first channels 11 arranged in pairs, and in one pair of the first channels 11, the end parts of the two first channels 11 in the length direction converge toward the direction close to each other.

Additionally/Alternatively, there are a plurality of second channels 25 arranged in pairs, and in one pair of the second channels 25, the end parts of the two second channels 25 in the length direction converge toward the direction close to each other.

In this way, the arrangement of the plurality of first channels 11 in pairs can improve the uniformity of the first channels 11 and thus improve the uniformity of the liquid inflow, enabling the operation of the liquid inflow to be convenient.

Specifically, there may be two, four, six, eight, or more even numbers of first channels 11. In one embodiment, there are four first channels 11. The end part of the first of the first channels 11 and the end part of the second of the first channels 11 are close to each other, and the end part of the third of the first channels 11 and the end part of the fourth of the first channels 11 are close to each other, while the end part of the second of the first channels 11 and the end part of the third of the first channels 11 are away from each other.

There may be two, four, six, eight, or more even numbers of second channels 25. In one embodiment, there may be four second channels 25. The end part of the first of the second channels 25 and the end part of the second of the second channels 25 are close to each other, and the end part of the third of the second channels 25 and the end part of the fourth of the second channels 25 are close to each other, while the end part of the second of the second channels 25 and the end part of the third of the second channels 25 are away from each other.

It may be that there are a plurality of first channels 11 arranged in pairs, and in one pair of the first channels 11, the end parts of the two first channels 11 in the length direction converge toward the direction close to each other. Alternatively, it may be that there are a plurality of second channels 25 arranged in pairs, and in one pair of the second channels 25, the end parts of the two second channels 25 in the length direction converge toward the direction close to each other. Or, it may be that there are a plurality of first channels 11 arranged in pairs and a plurality of second channels 25 arranged in pairs, where in one pair of the first channels 11, the end parts of the two first channels 11 in the length direction converge toward the direction close to each other, and in one pair of the second channels 25, the end parts of the two second channels 25 in the length direction converge toward the direction close to each other.

Referring to FIG. 2, in some embodiments, in one pair of the first channels 11, the two first channels 11 are symmetrically arranged in the length direction thereof. Additionally/Alternatively, in one pair of the second channels 25, the two second channels 25 are symmetrically arranged in the length direction thereof.

In this way, the symmetrical arrangement of the paired first channels 11 in the length direction of the first channels 11 can enable better consistency when the fluid is injected into the first channels 11, which is beneficial for achieving a reaction result with better overall stability.

Specifically, the symmetrical arrangement of two first channels 11 in the length direction thereof refers to that the first ends 112, the second ends 113, and the middle sections 111 of the two first channels 11 are all symmetrically arranged in the length direction of the first channels 11. In one embodiment, there are four first channels 11. The first of the first channels 11 and the second of the first channels 11 are symmetrically arranged in the length direction of the first channels 11, and the third of the first channels 11 and the fourth of the first channels 11 are symmetrically arranged in the length direction of the first channels 11. Certainly, the second of the first channels 11 and the third of the first channels 11 may also be symmetrically arranged in the length direction of the first channels 11.

The symmetrical arrangement of two second channels 25 in the length direction thereof refers to that the first ends, the second ends, and the middle sections of the two second channels 25 are symmetrically arranged in the length direction of the second channels 25. In one embodiment, there are four second channels 25. The first of the second channels 25 and the second of the second channels 25 are symmetrically arranged in the length direction of the second channels 25, and the third of the second channels 25 and the fourth of the second channels 25 are symmetrically arranged in the length direction of the second channels 25. Certainly, the second of the second channels 25 and the third of the second channels 25 may also be symmetrically arranged in the length direction of the second channels 25.

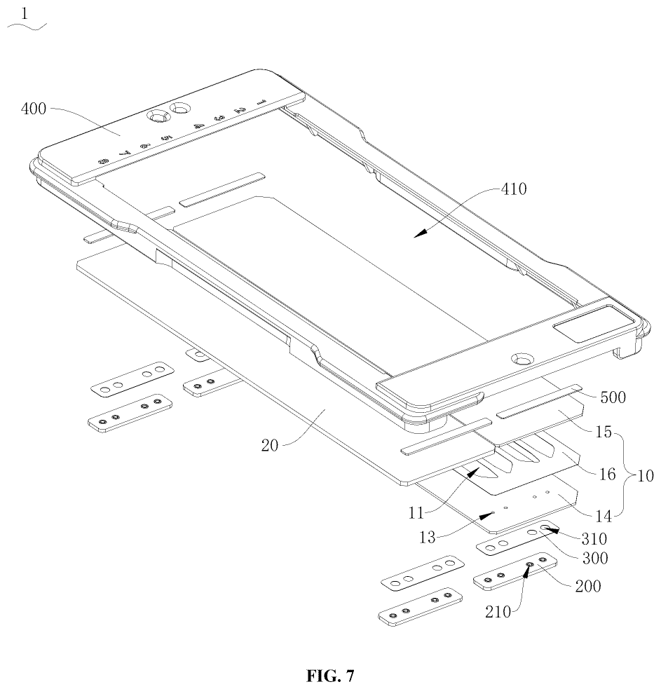

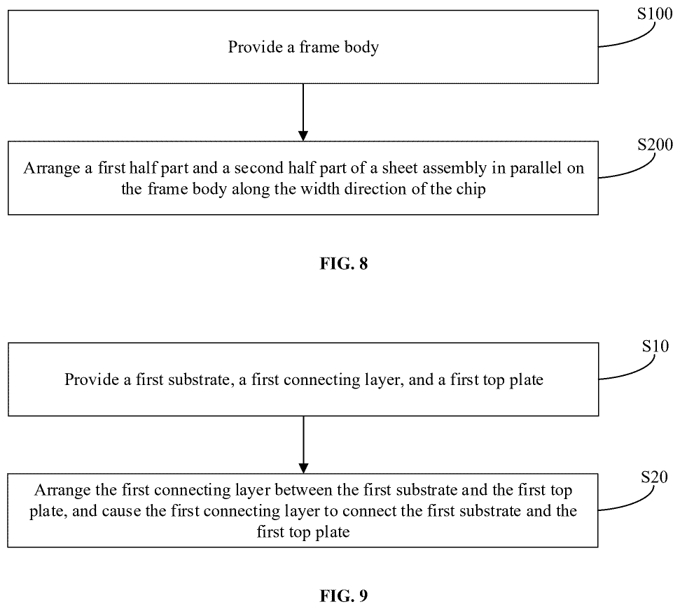

It may be that in one pair of the first channels 11, the two first channels 11 are symmetrically arranged in the length direction thereof. Alternatively, it may be that in one pair of the second channels 25, the two second channels 25 are symmetrically arranged in the length direction thereof. Or, it may be that in one pair of the first channels 11, the two first channels 11 are symmetrically arranged in the length direction thereof, and in one pair of the second channels 25, the two second channels 25 are symmetrically arranged in the length direction thereof. Referring to FIG. 8, the method for manufacturing the chip 1 according to the embodiments of the present disclosure includes: In S100, a frame body 400 is provided.

In S200, a first half part 10 and a second half part 20 of a sheet assembly 100 are arranged in parallel on the frame body 400 along the width direction of the chip 1.

In this way, through the above steps, the first half part 10 and the second half part 20 can be arranged on the frame body 400 to form the chip 1.

Specifically, the frame body 400 may be formed with a resin material by using an injection molding process. The first half part 10 and the second half part 20 may be fixedly connected to the surface of the frame body 400 through a fourth connecting layer 500. It may be that the first half part 10 is fixed on the frame body 400 first, and then the second half part 20 is fixed on the frame body 400; or it may be that the second half part 20 is fixed on the frame body 400 first, and then the first half part 10 is fixed on the frame body 400; or it may be that the first half part 10 and the second half part 20 are fixed on the frame body 400 simultaneously.

Referring to FIG. 9, in some embodiments, the first half part 10 is implemented by the following steps:

In S10, a first substrate 14, a first connecting layer 16, and a first top plate 15 are provided. In S20, the first connecting layer 16 is arranged between the first substrate 14 and the first top plate 15, and the first connecting layer 16 is caused to connect the first substrate 14 and the first top plate 15.

In this way, the first connecting layer 16 can connect and fix the first substrate 14 and the first top plate 15, forming the first half part 10.

Specifically, it may be that the first connecting layer 16 is connected to the first substrate 14 first, and the first top plate 15 is then connected to the first connecting layer 16. Alternatively, it may be that the first connecting layer 16 is connected to the first top plate first, and the first substrate 14 is then connected to the first connecting layer 16.

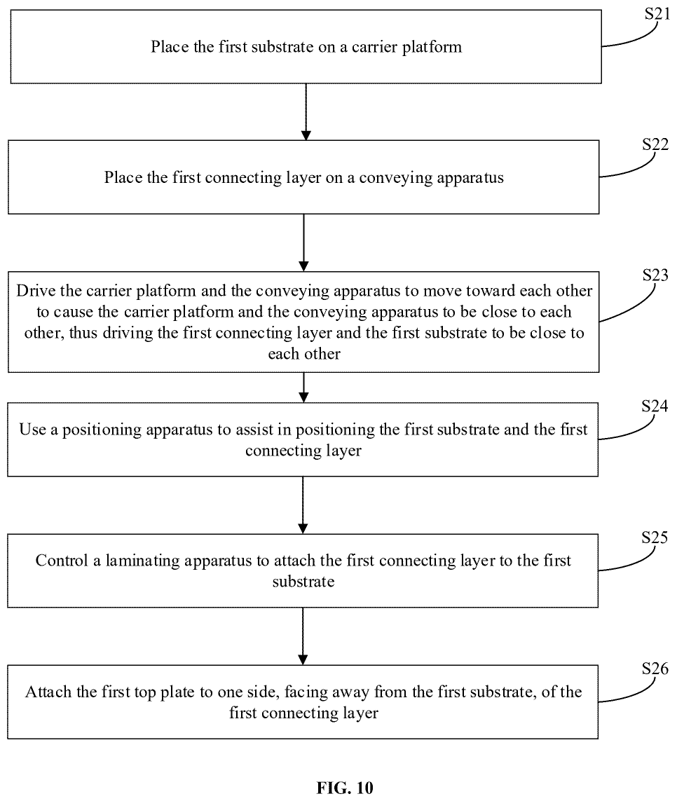

Referring to FIGS. 10 and 11, in some embodiments, arranging the first connecting layer 16 between the first substrate 14 and the first top plate 15 (step S20) includes: In S21, the first substrate 14 is placed on the carrier platform 2.

In S22, the first connecting layer 16 is placed on the conveying apparatus 3.

In S23, the carrier platform 2 and the conveying apparatus 3 are driven to move toward each other to cause the carrier platform 2 and the conveying apparatus 3 to be close to each other, thus driving the first connecting layer 16 and the first substrate 14 to be close to each other.

In S24, a positioning apparatus 4 is used to assist in positioning the first substrate 14 and the first connecting layer 16.

In S25, a laminating apparatus 5 is controlled to attach the first connecting layer 16 to the first substrate 14.

In S26, the first top plate 15 is attached to one side, facing away from the first substrate 14, of the first connecting layer 16.

In this way, by driving the conveying apparatus 3 and the carrier platform 2 to move toward each other and using the positioning apparatus 4 to assist in the precise positioning of the first substrate 14 and the first connecting layer 16, the attaching precision of the first connecting layer 16 and the first substrate 14 after being laminated by the laminating apparatus 5 is improved, thus reducing the defect in the assembly of the first substrate 14 and the first connecting layer 16.

Specifically, in step S21, the carrier platform 2 can provide support for the first substrate 14. The carrier platform 2 is provided with a mounting position, and the carrier platform 2 can create negative pressure to adsorb the first substrate 14 at the mounting position. The outer shape of the surface of the carrier platform 2 is not strictly limited. Illustratively, the carrier platform 2 may be of a substantially rectangular plate-like structure.

In step S22, the conveying apparatus 3 is provided with a mounting position, and the conveying apparatus 3 can create negative pressure to adsorb the first connecting layer 16 at the mounting position.

In step S23, the conveying apparatus 3 can move or rotate to convey the first connecting layer 16 from a loading position distal to the carrier platform 2 to an attaching position proximal to the carrier platform 2. The distance of the conveying apparatus 3 relative to the carrier platform 2 may be adjusted according to actual requirements.

In step S24, the positioning apparatus 4 may include a camera and a display screen. The camera and the display screen may be located above the carrier platform 2, and the conveying apparatus 3 may be located between the carrier platform 2 and the positioning apparatus 4.

In step S25, the laminating apparatus 5 may be a roller for rolling lamination or a plate-like structure for pressing lamination. The laminating apparatus 5 may roll along the length direction of the carrier platform 2 or move up and down along the height direction of the carrier platform 2, such that the first substrate 14 is tightly attached to the first connecting layer 16.

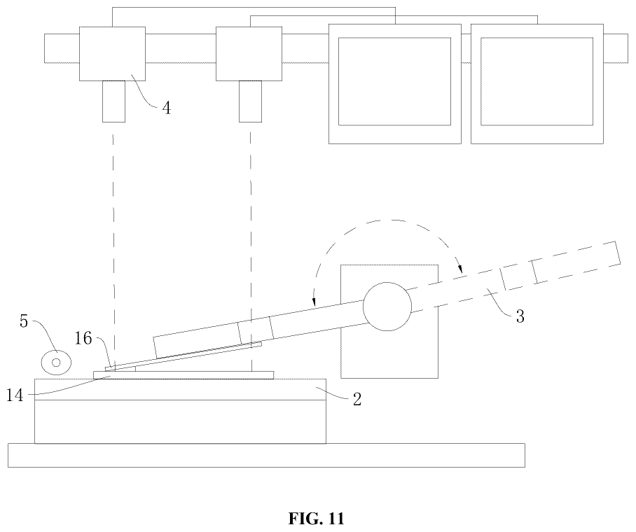

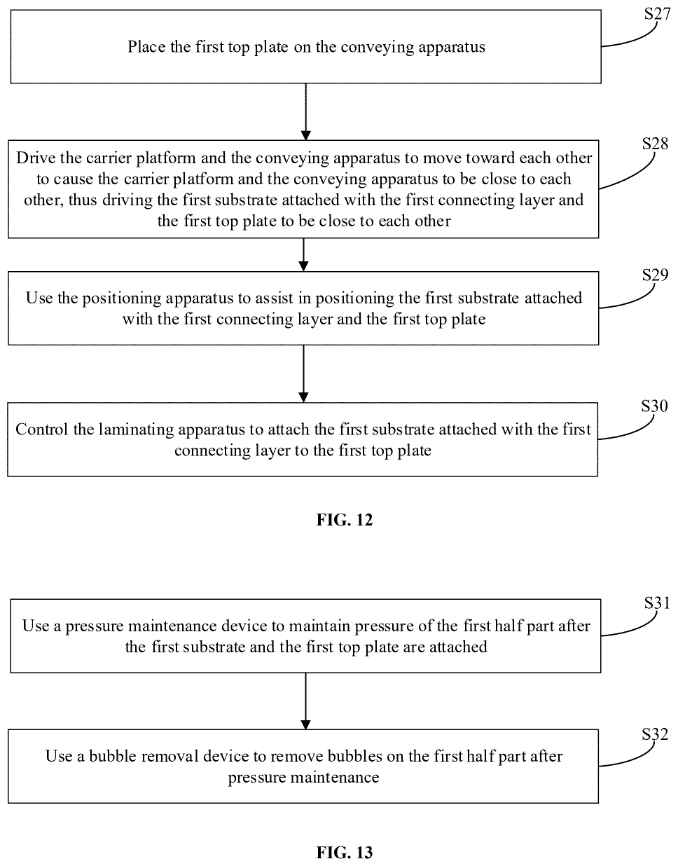

Referring to FIG. 12, in some embodiments, attaching the first top plate to one side, facing away from the first substrate, of the first connecting layer (step S26) includes:

In S27, the first top plate 15 is placed on the conveying apparatus 3.

In S28, the carrier platform 2 and the conveying apparatus 3 are driven to move toward each other to cause the carrier platform 2 and the conveying apparatus 3 to be close to each other, thus driving the first substrate 14 attached with the first connecting layer 16 and the first top plate 15 to be close to each other.

In S29, the positioning apparatus 4 is used to assist in positioning the first substrate 14 attached with the first connecting layer 16 and the first top plate 15.

In S30, the laminating apparatus 5 is controlled to attach the first substrate 14 attached with the first connecting layer 16 to the first top plate 15.

In this way, by driving the conveying apparatus 3 and the carrier platform 2 to move toward each other and using the positioning apparatus 4 to assist in the precise positioning of the first substrate 14 attached with the first connecting layer 16 and the first top plate 15, the attaching precision of the first substrate 14 attached with the first connecting layer 16 and the first top plate 15 after being laminated by the laminating apparatus 5 is improved, thus reducing the defect in the assembly of the first substrate 14 attached with the first connecting layer 16 and the first top plate 15.

Specifically, in step S27, the conveying apparatus 3 is provided with a mounting position, and the conveying apparatus 3 can create negative pressure to adsorb the first top plate 15 at the mounting position.

In step S28, the conveying apparatus 3 can move or rotate to convey the first top plate 15 from a loading position distal to the carrier platform 2 to an attaching position proximal to the carrier platform 2. The distance of the conveying apparatus 3 relative to the carrier platform 2 may be adjusted according to actual requirements.

In step S29, the positioning apparatus 4 may include a camera and a display screen. The camera and the display screen may be located above the carrier platform 2, and the conveying apparatus 3 may be located between the carrier platform 2 and the positioning apparatus 4.

In step S30, the laminating apparatus 5 may be a roller for rolling lamination or a plate-like structure for pressing lamination. The laminating apparatus 5 may roll along the length direction of the carrier platform 2 or move up and down along the height direction of the carrier platform 2, such that the first substrate 14 attached with the first connecting layer 16 is tightly attached to the first top plate 15.

Referring to FIG. 13, in some embodiments, after controlling the laminating apparatus 5 to attach the first substrate 14 attached with the first connecting layer 16 to the first top plate 15, the method further includes:

In S31, a pressure holding device is used to maintain the pressure of the first half part 10 after the first substrate 14 and the first top plate 15 are attached.

In S32, a bubble removal device is used to remove bubbles on the first half part 10 after pressure maintenance.

In this way, by performing the pressure maintenance and bubble removal on the first half part 10 after the first substrate 14 and the first top plate 15 are attached, the adhesion between the first substrate 14 and the first top plate 15 can be increased and the structural stability of the first half part 10 can be improved.

Specifically, in step S31, the pressure maintenance pressure and the pressure maintenance time of the pressure holding device may be preset, then the first half part 10 is placed into the pressure maintenance station of the pressure holding device, and the start button is pressed, in which case the pressure maintenance is performed on the first half part 10. In one embodiment, the pressure holding device is provided with one pressure maintenance mechanism, which may maintain the pressure of the first substrate 14 first and then the pressure of the first top plate 15, or may maintain the pressure of the first top plate 15 first and then the pressure of the first substrate 14. In another embodiment, the pressure holding device is provided with one upper pressure maintenance mechanism and one lower pressure maintenance mechanism, which may maintain the pressure of the first substrate 14 and the pressure of the first top plate 15 simultaneously.

In step S32, during the attaching process, bubbles are generated between the first substrate 14 and the first connecting layer 16 and between the first top plate 15 and the first connecting layer. The bubble removal device injects high-pressure gas into the chamber by using an air compressor, such that a working environment maintaining high pressure is created in the chamber. When the first half part 10 with bubbles is placed into the chamber, the high-pressure environment in the chamber and the air in the first half part 10 form a pressure difference, such that the bubbles in the first half part 10 are squeezed out, thus achieving the effect of removing bubbles.

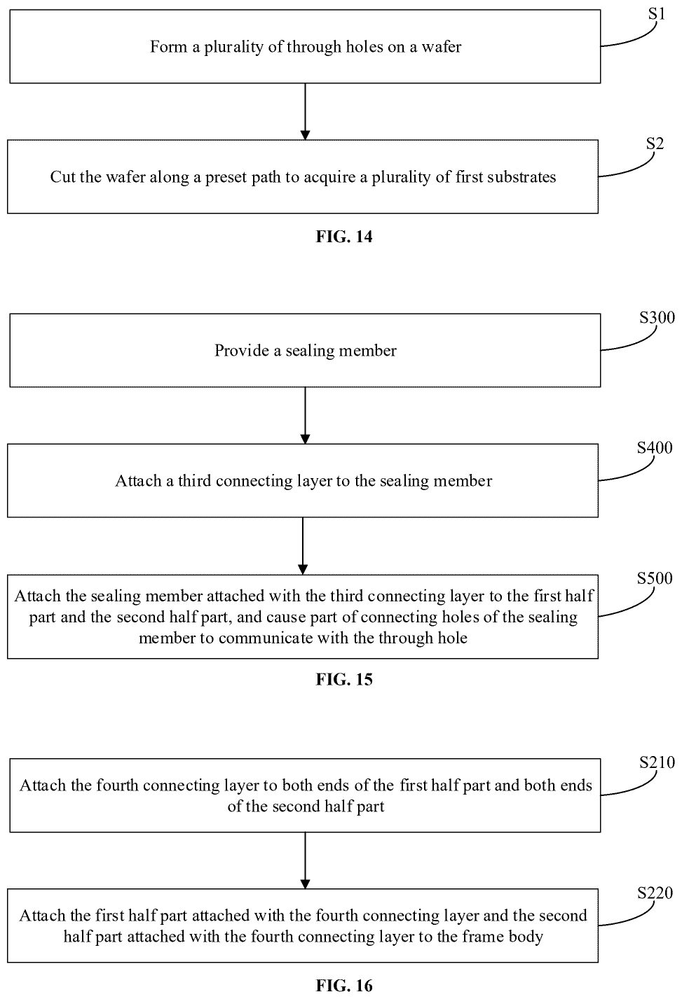

Referring to FIG. 14, in some embodiments, the first substrate 14 is implemented by the following steps:

In S1, a plurality of through holes 13 are formed on a wafer.

In S2, the wafer is cut along a preset path to acquire a plurality of first substrates 14. In this way, by forming the through holes 13 on the wafer first and then cutting the wafer along the preset path to acquire the first substrates 14, it can be determined whether the cutting path is the preset path based on the position of the through holes 13 on the first substrates 14, which facilitates the adjustment of the cutting path in advance, improving the production yield of the first substrates 14, and thus reducing the production cost of the first substrates 14.

Specifically, the preset path refers to the cutting path on the wafer that forms the first substrates 14, and the preset path also constitutes the contour shape of the edges of all the first substrates 14 cut from the wafer. That is, by cutting along a preset path, the first substrates 14 can be separated from the wafer.

In the embodiment, the cutting path on the wafer may be designed by using the existing drafting or modeling software, and the embodiments of the present disclosure do not specifically limit the drafting or modeling software used in designing the preset path. It can be understood that the step of designing the preset path may be performed while preparing the current first substrate 14, i.e., the preset path of the current first substrate 14 is designed before the cutting operation is performed. Alternatively, the execution method corresponding to the cutting of the first substrate 14 of the same specification may be saved when performed for the first time, and later, the previously saved execution method may be invoked in the step of cutting the first substrate 14 of the same specification from the wafer of the same specification, thus reusing the existing design scheme of the preset path.

In step S2, the preset path may be set on the wafer based on the area of the first substrate 14 required and the area of the wafer, and by cutting along the preset path, one or more first substrates 14 can be acquired. It should be understood that the preset path may include one or more cutting path units, and by cutting along each cutting path unit, one corresponding first substrate 14 can be acquired. The number of the cutting path units on the wafer is determined based on the area of the first substrate 14 required and the area of the wafer. In one effective embodiment, the number of the cutting path units is the maximum number of first substrates 14 available within the effective area of the wafer. In one possible embodiment, one cutting path unit corresponding to the shape of the edge of the first substrate 14 is set on the wafer, and no matter how the cutting path unit is set, other areas outside the cutting path unit are not enough to form a second identical cutting path unit. In another possible embodiment, two cutting path units corresponding to the shape of the edge of the first substrate 14 are set on the wafer, and no matter how the cutting path units are set, other areas outside the two cutting path units are not enough to form a third identical cutting path unit. In yet another possible embodiment, n cutting path units corresponding to the shape of the edge of the first substrate 14 are set on the wafer, and no matter how the cutting path units are set, other areas outside the n cutting path units are not enough to form a (n+1)th identical cutting path unit.

Referring to FIG. 15, in some embodiments, the manufacturing method further includes: In S300, a sealing member 200 is provided.

In S400, a third connecting layer 300 is attached to the sealing member 200.

In S500, the sealing member 200 attached with the third connecting layer 300 is attached to the first half part 10 and the second half part 20, and part of the connecting hole 210 of the sealing member 200 is caused to communicate with the through hole 13.

In this way, the connecting hole 210 can communicate the through hole 13 with an external components, and the sealing member 200 can seal the connection between the first substrate 14 and the external components, reducing the probability of leakage of the reagent solution.

Specifically, in step S300, there may be four sealing members 200, and the four scaling members 200 are attached to both ends of the first half part 10 and both ends the second half part 20, respectively.

In step S400, there may be four third connecting layers 300. The four third connecting layers 300 may be sequentially attached to the four sealing members 200, for example, two of the third connecting layers 300 are attached to two of the sealing members 200 first, and then the other two third connecting layers 300 are attached to the other two sealing members 300. Alternatively, the four third connecting layers 300 may be attached to the four scaling members 200 simultaneously.

In step S500, it may be that two of the sealing members 200 attached with the third connecting layers 300 are attached to both ends of the bottom surface of the first half part 10 first, and then the other two sealing members 200 attached with the third connecting layers 300 are attached to both ends of the bottom surface of the second half part 20. Alternatively, it may be that two of the sealing members 200 attached with the third connecting layers 300 are attached to one end of the bottom surface of the first half part 10 and one end of the bottom surface of the second half part 20 first, and then the other two sealing members 200 attached with the third connecting layers 300 are attached to the other end of the bottom surface of the first half part 10 and the other end of the bottom surface of the second half part 20. Or, it may be that the four sealing members 200 attached with the third connecting layers 300 are attached to both ends of the bottom surface of the first half part 10 and both ends of the bottom surface of the second half part 20 simultaneously.

Referring to FIG. 16, in some embodiments, arranging the first half part 10 and the second half part 20 of the sheet assembly 100 in parallel on the frame body 400 along the width direction of the chip 1 (step S200) includes:

In S210, a fourth connecting layer 500 is attached to both ends of the first half part 10 and the second half part 20.

In S220, the first half part 10 and the second half part 20, which are attached with the fourth connecting layer 500, are attached to the frame body 400.

In this way, the first half part 10 and the second half part 20 can be arranged in parallel on the frame body 400 along the width direction of the chip 1 to form the chip 1.

Specifically, in step S210, there may be four fourth connecting layers 500. It may be that two of the fourth connecting layers 500 are attached to both ends of the top surface of the first half part 10 first, and then the other two fourth connecting layers 500 are attached to both ends of the top surface of the second half part 20. Alternatively, it may be that the four fourth connecting layers 500 are attached to both ends of the top surface of the first half part 10 and both ends of the top surface of the second half part 20 simultaneously.

In step S220, it may be that the first half part 10 attached with the fourth connecting layer 500 is attached to the bottom surface of the frame body 400 first, and then the second half part 20 attached with the fourth connecting layer 500 is attached to the bottom surface of the frame body 400. Alternatively, it may be that the first half part 10 and the second half part 20, which are attached with the fourth connecting layer 500, are attached to the bottom surface of the frame body 400 simultaneously.

In the description of the specification, references to the terms such as “an embodiment”, “some embodiments”, “schematic embodiments”, “examples”, “specific examples”, or “some examples” mean that the specific feature, structure, material, or characteristic described in connection with the embodiment or example is included in at least one embodiment or example of the present disclosure. In the specification, the schematic description of the aforementioned terms does not necessarily refer to the same embodiment or example. Moreover, the specific feature, structure, material, or characteristic described may be combined in any one or more embodiments or examples in an appropriate manner.

Although the embodiments of the present disclosure have been illustrated and described, it can be understood by those of ordinary skill in the art that various changes, modifications, replacements, and variations can be made to these embodiments without departing from the principle and purpose of the present disclosure, and the scope of the present disclosure is defined by the claims and equivalents therefore.

1-10. (canceled)

11. A chip, comprising a sheet assembly, the sheet assembly comprising a first half part and a second half part arranged in parallel with the first half part along a width direction of the chip, wherein the first half part is provided with a first channel;
the first half part is provided with a first bottom surface, and a through hole that penetrates through the first bottom surface and communicates with the first channel is formed on the first half part; and
the second half part is provided with a second bottom surface flush with the first bottom surface, the second bottom surface being a structurally continuous unbroken plane.

12. The chip according to claim 11, wherein the first half part and the second half part are of a split structure.

13. The chip according to claim 11, wherein the first half part comprises a first substrate and a first top plate arranged opposite the first substrate, the first channel is formed between the first substrate and the first top plate, the first substrate is provided with the first bottom surface, and the through hole is formed on the first substrate.

14. The chip according to claim 13, wherein the first half part further comprises a first connecting layer arranged between the first substrate and the first top plate, the first channel is formed on the first connecting layer, and the first channel penetrates through the first connecting layer in a thickness direction of the first connecting layer.

15. The chip according to claim 11, wherein the second half part comprises a second substrate and a second top plate arranged opposite the second substrate, the second substrate is provided with the second bottom surface, and a second channel is formed between the second substrate and the second top plate.

16. The chip according to claim 15, wherein the second half part further comprises a second connecting layer arranged between the second substrate and the second top plate, the second channel is formed on the second connecting layer, and the second channel penetrates through the second connecting layer in a thickness direction of the second connecting layer.

17. The chip according to claim 15, wherein the second half part comprises a second substrate, a second top plate, and a second connecting layer arranged between the second substrate and the second top plate, the second substrate is provided with the second bottom surface, and the second connecting layer is a structurally continuous solid sheet.

18. The chip according to claim 17, wherein the first connecting layer and the second connecting layer are of an integrated structure.

19. The chip according to claim 15, wherein the first top plate and the second top plate are of a split structure, and the first substrate and the second substrate are of a split structure.

20. The chip according to claim 11, wherein the second half part is a plate member of an integrated structure.

21. The chip according to claim 11, wherein an end part of the first channel in a length direction is in a converged state, and the through hole communicates with the end part of the first channel in the length direction thereof;
there are a plurality of the first channels, and in two first channels on outer sides, end parts of the first channels in the length direction converge toward a direction close to each other; and
there are a plurality of the first channels arranged in pairs, wherein in one pair of the first channels, end parts of the two first channels in the length direction converge toward the direction close to each other.

22. The chip according to claim 11, wherein when the chip is provided with a second channel, an end part of the second channel in a length direction is in a converged state, and the through hole communicates with the end part of the second channel in the length direction thereof;
there are a plurality of the second channels, and in two second channels on outer sides, end parts of the second channels in the length direction converge toward a direction close to each other; and
there are a plurality of the second channels arranged in pairs, wherein in one pair of the second channels, end parts of the two second channels in the length direction converge toward the direction close to each other.

23. A method for manufacturing a chip, comprising:
providing a frame body; and
arranging a first half part and a second half part of a sheet assembly in parallel on the frame body along a width direction of the chip, wherein the first half part is provided with a first channel, the first half part is provided with a first bottom surface, and a through hole that penetrates through the first bottom surface and communicates with the first channel is formed on the first half part, wherein the second half part is provided with a second bottom surface flush with the first bottom surface, the second bottom surface being a structurally continuous unbroken plane.

24. The manufacturing method according to claim 23, wherein the first half part is implemented by following steps:
providing a first substrate, a first connecting layer, and a first top plate, wherein the first channel is formed on the first connecting layer; the first substrate is provided with the first bottom surface, and the through hole is formed on the first substrate; the first channel penetrates through the first connecting layer in a thickness direction of the first connecting layer; and
arranging the first connecting layer between the first substrate and the first top plate, and causing the first connecting layer to connect the first substrate and the first top plate.

25. The manufacturing method according to claim 24, wherein arranging the first connecting layer between the first substrate and the first top plate comprises:
placing the first substrate on a carrier platform;
placing the first connecting layer on a conveying apparatus;
driving the carrier platform and the conveying apparatus to move toward each other to cause the carrier platform and the conveying apparatus to be close to each other, thus driving the first connecting layer and the first substrate to be close to each other;
using a positioning apparatus to assist in positioning the first substrate and the first connecting layer;
controlling a laminating apparatus to attach the first connecting layer to the first substrate; and
attaching the first top plate to one side, facing away from the first substrate, of the first connecting layer.

26. The manufacturing method according to claim 25, wherein attaching the first top plate to the one side, facing away from the first substrate, of the first connecting layer comprises: placing the first top plate on the conveying apparatus;
driving the carrier platform and the conveying apparatus to move toward each other to cause the carrier platform and the conveying apparatus to be close to each other, thus driving the first substrate attached with the first connecting layer and the first top plate to be close to each other;
using the positioning apparatus to assist in positioning the first substrate attached with the first connecting layer and the first top plate; and
controlling the laminating apparatus to attach the first substrate attached with the first connecting layer to the first top plate.

27. The manufacturing method according to claim 26, wherein after controlling the laminating apparatus to attach the first substrate attached with the first connecting layer to the first top plate, the method further comprises:
using a pressure holding device to maintain pressure of the first half part after the first substrate and the first top plate are attached; and
using a bubble removal device to remove bubbles on the first half part after pressure maintenance.

28. The manufacturing method according to claim 24, further comprising:
providing a sealing member;
attaching a third connecting layer to the sealing member; and
attaching the sealing member attached with the third connecting layer to the first half part and the second half part, and causing part of connecting holes of the sealing member to communicate with the through hole.

29. The manufacturing method according to claim 24, wherein arranging the first half part and the second half part of the sheet assembly in parallel on the frame body along the width direction of the chip comprises:
attaching a fourth connecting layer to both ends of the first half part and the second half part; and
attaching the first half part and the second half part, which are attached with the fourth connecting layer, to the frame body.

30. The manufacturing method according to claim 29, wherein the second half part is a plate member of an integrated structure.
